(19) United States
(12) Patent Application Publication
(10) Pub. No.: US 2020/0228944 A1
(43) Pub. Date: Jul. 16, 2020

(54) CONTROLLING PHYSICAL PROCUREMENT AT POINT OF PURCHASE

(71) Applicant: International Business Machines Corporation, Armonk, NY (US)

(72) Inventors: Michael Bender, Rye Brook, NY (US); Jeremy R. Fox, Georgetown, TX (US); Kulvir Bhogal, Fort Worth, TX (US)

(73) Assignee: International Business Machines Corporation, Armonk, NY (US)

(21) Appl. No.: 16/244,958

(22) Filed: Jan. 10, 2019

(51) Int. Cl. H04W 4/35; H04W 4/80; G06Q 30/06

(52) U.S. Cl. CPC H04W 4/35; G06Q 30/0635; G06Q 30/0631; H04W 4/80

(57) ABSTRACT

Using a broadcast signal from a physical item repository and a response to the broadcast signal, a device within a range of the broadcast signal is detected. From information received from the device using a processor and a memory, profile information comprising a tracked inventory of an item is determined. By activation of a sensor, an addition of the item to the physical item repository is detected. Using the tracked inventory of the item and a model, a usage rate corresponding to the item is predicted. Responsive to the detecting, a warning condition corresponding to the item relative to the predicted usage rate of the item is determined. In response to the determining, the warning condition is nullified based on an exception condition.

### TECHNICAL FIELD

The present invention relates generally to a method, system, and computer program product for point of purchase need determination of items being purchased. More particularly, the present invention relates to a method, system, and computer program product for controlling physical procurement at point of purchase.

### BACKGROUND

Despite the growth of online commerce, offline commerce, involving physical, or brick and mortar, locations, is still an important commercial sector. As used herein, offline commerce refers to commerce involving at least one physical location where customers can physically view an item before buying it. While online commerce involves pictures or text descriptions of an item available for purchase, offline commerce includes access to a physical item. In offline commerce, customers can assess a physical item's characteristics in person, quickly answering questions such as: Does this piece of clothing fit? Is this nut the right size for this bolt? Does this fabric feel soft? Is this fruit ripe? Is this coat warm enough? As well, customers need not wait for shipping, providing immediate gratification. However, customers are now used to the enhanced purchasing features often available in online commerce—such as shopping lists, user profile integration, purchasing recommendations, targeted item promotions, and the like—and would like access to those same purchasing features when shopping offline.

### SUMMARY

The illustrative embodiments provide a method, system, and computer program product. An embodiment includes a method that detects, using a broadcast signal from a physical item repository and a response to the broadcast signal, a device within a range of the broadcast signal. An embodiment determines, from information received from the device using a processor and a memory, profile information comprising a tracked inventory of an item. An embodiment detects, by activation of a sensor, an addition of the item to the physical item repository. An embodiment predicts, using the tracked inventory of the item and a model, a usage rate corresponding to the item. An embodiment determines, responsive to the detecting, a warning condition corresponding to the item relative to the predicted usage rate of the item. An embodiment nullifies, in response to the determining, the warning condition based on an exception condition.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for controlling physical procurement at point of purchase in accordance with an illustrative embodiment;

FIG. 4 depicts more detail of a block diagram of an example configuration for controlling physical procurement at point of purchase in accordance with an illustrative embodiment;

FIG. 5 depicts more detail of a block diagram of an example configuration for controlling physical procurement at point of purchase in accordance with an illustrative embodiment;

FIG. 6 depicts examples of the use of an example configuration for controlling physical procurement at point of purchase in accordance with an illustrative embodiment;

FIG. 7 depicts a flowchart of an example process for controlling physical procurement at point of purchase in accordance with an illustrative embodiment;

FIG. 8 depicts another flowchart of an example process for controlling physical procurement at point of purchase in accordance with an illustrative embodiment;

FIG. 9 depicts another flowchart of an example process for controlling physical procurement at point of purchase in accordance with an illustrative embodiment;

FIG. 10 depicts another flowchart of an example process for controlling physical procurement at point of purchase in accordance with an illustrative embodiment; and

FIG. 11 depicts another flowchart of an example process for controlling physical procurement at point of purchase in accordance with an illustrative embodiment.

### DETAILED DESCRIPTION

The illustrative embodiments recognize that managing a purchaser's stock of physical items, especially perishable items, is important in offline commerce. Purchasing more items than needed is inefficient, necessitating additional storage space for the additional items and tying up capital used to buy the excess. As well, holding excess stock of perishable items can result in waste, if items expire before they can be used. However, purchasing more items than currently needed may also be advantageous, if the items are subject to a temporary or quantity discount, can be stored until use, and can be used before any applicable expiration date.

The illustrative embodiments recognize that purchasers often do not buy exactly what they need. They may forget what they already have, and buy excess. They may forget they need more, fewer, or different items from their usual purchases. A shopping list may help, but purchasers may also add too many or too few items to the list, may forget to check current stock before adding an item to the list—and may not have access to the list when at the physical store. A needed item may be out of stock or have a short expiration date, necessitating a substitution of item, store, or another change of plan. A purchaser may also buy an unneeded item—for example, because the item looks good, smells good, is on sale, or simply makes a purchaser happy. The illustrative embodiments recognize that purchasers need to intercept such behavior at the place of purchase, before actually purchasing an unneeded item.

The illustrative embodiments recognize that the presently available tools or solutions do not address these needs or problems or provide adequate solutions for these needs or problems. The illustrative embodiments used to describe the invention generally address and solve the above-described problems and other problems related to controlling physical procurement at point of purchase.

An embodiment can be implemented as a software application. The application implementing an embodiment can be configured as a modification of an existing shopping assistant system, as a separate application that operates in conjunction with an existing shopping assistant system, a standalone application, or some combination thereof.

Particularly, some illustrative embodiments provide a method by which a physical shopping cart and a purchaser can be associated, a purchaser's depositing an item into the physical shopping cart can be detected, and, based on information associated with the purchaser, the item can be determined to be unneeded or unsuitable and the purchaser warned prior to purchase.

As used herein, a physical shopping cart is an apparatus in which a purchaser can accumulate and temporarily store one or more physical items intended to be purchased, before actually purchasing the items. Such a physical shopping cart includes an item depository, such as a basket or another area within which items can be placed. The item depository may be supported by wheels and be meant to be pushed by a purchaser, or be without wheels and small enough and light enough to be hand-carried by a purchaser. A physical shopping cart can also be a combination of an item depository with another function (such as a combination stroller-shopping cart including a seat for a child and a section for placing items to be purchased). The item depository can be made of metal, plastic, or any other suitable material or combination of materials, and the depository can be of any volume suitable for containing physical items displayed or sold at the offline commerce location and available for manipulation by a purchaser. A physical shopping cart, as used herein, also includes a processor, memory, and storage device capable of storing and executing a software application, a communication apparatus, and a component, such as a weight or dimensions sensor, for detecting one or more physical items as a purchaser places items into the physical shopping cart. One or more components of the physical shopping cart need not be physically affixed to the physical shopping cart, but instead be remote from but able to monitor the physical shopping cart, for example by using a camera at the offline commerce location positioned to monitor the physical shopping cart.

An embodiment associates a physical shopping cart and a purchaser, using a device associated with the purchaser as a proxy for the purchaser. In one embodiment, an application executing on an appropriately-equipped physical shopping cart causes a communication apparatus in the cart to broadcast a request for a response from a device associated with the purchaser that is capable of responding to such a request. The communications apparatus is sufficiently short-range as to differentiate between one purchaser using one physical shopping cart and another purchaser using another physical shopping cart within the offline commerce location. Bluetooth (Bluetooth is a registered trademark of Bluetooth SIG, Inc.) and Near Field Communication (Near Field Communication is a registered trademark of GreetingTap LLC) are examples of a suitable communications apparatus. The embodiment receives a response from a device associated with the purchaser, including user identification information for the purchaser. The cart and the purchaser are now deemed to be associated. In other words, this cart and this purchaser are sufficiently proximate that this purchaser can be assumed to be using this cart to accumulate physical items as the purchaser shops, and any item placed in this cart should be assessed against information relating to this purchaser.

An embodiment uses the identification information for the associated purchaser to obtain profile data for the purchaser. In an embodiment, profile data includes a shopping list—a list of items a purchaser intends to purchase. An embodiment can be configured to receive shopping list information from another application, for use in the embodiment. An embodiment can also be configured to maintain a shopping list. An embodiment uses a shopping list that has been created either manually by the user or automatically by another application or device.

In an embodiment, profile data includes stock information for the item added to the physical shopping cart for potential purchase. Stock information includes whether or not the purchaser already has a stock of the item, a quantity of the item, if any, that is currently stocked, expiration data and other age information associated with the current stock of the item, and data showing when which items come into storage and when they are used or must be discarded for expiration or other concerns. Another embodiment obtains stock information from another application, for example an application dedicated to stock management or an IoT device.

In an embodiment, profile data includes information from the purchaser's calendar, to-do list, reminder application, or another application maintaining information relevant to a purchaser's potential purchases. An embodiment uses such data to process exceptions to a usage rate prediction for the item, only with user permission via an opt-in or opt-out mechanism of the present invention. A user consumes an item at a certain rate. That rate of consumption is referred to herein as a “usage rate”. The user's consumption of an item is dependent on a variety of factors—such as parties, holidays, guests, and the like, and the usage rate changes in relation to one or more factors. A prediction of a future rate of consumption is referred to herein as a usage rate prediction. For example, if a purchaser's calendar information includes data such as “ten guests for dinner Saturday”, the purchaser can be expected to buy more and different items than usual to accommodate the ten expected guests. On the other hand, if a purchaser's calendar information includes data such as airplane tickets for a week-long trip, a purchaser can be expected to buy a smaller quantity of food items than usual because the purchaser will not be at home to consume them.

In an embodiment, profile data includes information about other sources of information—for example, social media data—that influence the user's shopping. from other users related to the purchaser. An embodiment uses such additional data to populate or update a shopping list and to process exceptions to a usage rate prediction for the item, only with user permission via an opt-in or opt-out mechanism of the present invention. Thus, if two or more purchasers maintain a common stock of purchased items and share purchasing duties, an embodiment takes both purchasers' shopping lists, schedules, to-do lists, and other profile information into account when assessing a need for an item. For example, if two purchasers live together but one will be traveling, consumption for the common household can be expected to decrease while the traveling purchaser is away.

An embodiment monitors the environment within and around a physical shopping cart to detect an item addition to the cart. One embodiment uses a combination of an RFID tag affixed to a physical item and an RFID tag reader configured to detect the RFID-tagged item as the item enters a volume of the physical cart monitored by the RFID tag reader. Another embodiment uses a weight sensor to monitor a physical location, such as a shelf or floor area, where a particular item is known to be stored, and a second weight sensor within the physical shopping cart to detect that an item of matching weight is placed into the cart. Another embodiment uses a camera to monitor an item storage location and a physical cart and determine from image analysis when a particular item is moved from the storage location to the cart. Another embodiment uses an Internet of Things (IoT) device, affixed to a physical item and capable of reporting the item's movement from a storage location to a physical cart. IoT devices include sufficient software, sensing, and communications capability to connect, collect and exchange data with other networked devices, for example using the Internet. Another embodiment uses a combination of one or more monitoring and detection implementations. Additional monitoring and detection implementations are also implementable and contemplated within the scope of the illustrative embodiments.

An embodiment also gathers information about the detected item. In one embodiment, the information includes a description of the item (e.g., “Brand X Greek-style Strawberry Yogurt, 250 ml size”). In another embodiment, the information includes an expiration date of the item, if one is applicable. In another embodiment, the information includes a lot number of the item and an expiration date of the entire lot. Tracking expiration dates by lots avoids having to associate a specific expiration data with each individual item. In another embodiment, the information includes information regarding any temporary or quantity discounts that may be available for the item, for use in determining if an unneeded item should be purchased anyway. Other information pertaining to the item may also be available and is contemplated within the scope of the illustrative embodiments.

An embodiment predicts a usage rate of an item based on the stock information of the item and a purchaser's historical usage of the item, derived from the stock information. One embodiment maintains predicted usage rates of items for which the embodiment also maintains stock information. For example, if an embodiment tracks a purchaser's regular milk stock, the embodiment also maintains a predicted usage rate for this type of milk. Another embodiment is triggered to predict a usage rate for an item when a physical shopping cart detects that the item has been placed in a cart associated with a purchaser. For example, this embodiment predicts a purchaser's usage rate for milk when the purchaser adds a container of milk to a cart.

In either case, an embodiment constructs a forecasting model that predicts future usage, based on tracked stock information, historical patterns, calendar and other profile information, and other information that influences the predicted usage rate in a manner described herein. For example, if the stock information indicates that a purchaser has a historical pattern of entering seven containers of yogurt into storage every Saturday, an embodiment can predict that the purchaser's usage rate for this particular type of yogurt is one yogurt container per day. However, if the stock information indicates that a purchaser has a historical pattern of entering seven containers of yogurt into storage every Saturday, discarding two opened containers of yogurt over the course of a week, and discarding five unopened but expired containers of yogurt every Friday evening, an embodiment can predict that this purchaser's usage rate for this particular type of yogurt is actually two yogurt containers per week, even though the purchaser is buying seven.

An embodiment determines a warning condition corresponding to the item and the user profile information. One example warning condition is the item's absence from a shopping list for the purchaser. If the item is not present in the purchaser's shopping list, it is more likely that this item is not something a user needs, but instead something the purchaser is considering purchasing for other reasons. Another example warning condition is be that the item will expire or otherwise become unusable before the item is expected to be used, based on the predicted usage rate of the item. For example, if the purchaser places seven containers of yogurt in the cart, but each container of yogurt will expire tomorrow, only one container of yogurt will be expected to have been used, at the predicted usage rate of one container per day, before the remaining containers of yogurt expire. Items that expire before they can be used are wasted, and thus merit a warning. Another example warning condition is that there is already sufficient stock of the item to meet the predicted usage rate and any applicable expiration date of the item before the next time the purchaser is expected to be at a physical location where the item can be purchased. For example, if a predicated usage rate of bottles of water is one per day, the purchaser shops once a week, and the purchaser already has 24 bottles of water in stock, there is no immediate need to buy more water because the existing stock is sufficient to meet the predicted usage rate and will not expire soon. Thus, a warning is merited here as well. Other warning conditions are also possible and contemplated within the scope of the illustrative embodiments.

An embodiment modifies or nullifies a warning condition based on an exception condition corresponding to the item and the user profile information. Such a modification or nullification means that even though a warning condition exists, an exception condition also exists that modifies or negates the need for a warning. One example exception condition is that the item is on sale or subject to a quantity discount and will not expire before use based on the predicted usage rate. Thus, even though a warning condition has been raised that the purchaser is contemplating purchasing excess stock of the item, because the item is on sale or subject to a quantity discount, and the purchaser can store the excess quantity, it is to the user's advantage to stock extra of the item. Thus, the excess items in the physical cart do not merit a warning after all. Another example condition is that the usage rate of the item is predicted to change, and the new usage rate would cancel the warning condition. For example, if a purchaser normally uses seven containers of yogurt per week, but this week is contemplating fourteen, the excess would generate a warning condition. However, this purchaser will have a house guest this week who also uses seven containers of yogurt per week, so the excess is justified. Thus, the exception condition nullifies the warning condition, and no warning is merited. Another example exception condition is that the current stock will expire before it can be used, so that fresh stock is required. For example, even though a purchaser has seven containers of yogurt in stock, those containers have already expired, and fresh stock is required. Thus, the exception condition nullifies the warning condition, and no warning is merited. Other exception conditions are also possible and contemplated within the scope of the illustrative embodiments.

Another embodiment reports item addition and associated user identification information to a remote application. The remote application accesses profile information corresponding to the user associated with the cart, computes a usage rate relating to the item added to the cart, determines whether a warning condition exists relative to the usage rate for that item, determines whether an exception condition modifies or nullifies the warning condition, and reports status information corresponding to the item addition back to the application reporting the item addition.

If an embodiment determines that a warning condition exists with respect to an item a purchaser has added to a physical shopping cart, and no exception condition exists to nullify the warning, One embodiment notifies the purchaser directly, for example using a message, light, or sound produced by the physical cart. One exemplary message might be, “It looks like you don't need that item. Please consider putting it back.” Another, more detailed, exemplary message might be, “It looks like five of those yogurts will expire before you eat them. I suggest only buying two.” Another embodiment reports the information to another application that warns the purchaser. In one embodiment, the other application executes on a mobile device associated with the purchaser. In another embodiment, the other application executes on a server or other device remote from the cart and purchaser and sends a message, such as a text, email, or push notification, to a device or account associated with the purchaser. These reporting modalities are non-limiting examples, and other reporting modalities are also contemplated within the scope of the exemplary embodiments.

The embodiments described herein provide a purchaser-based system, making information relating to the purchaser accessible at any physical store. The embodiments described herein also provide a store-based system in which purchaser information relating to any purchaser is accessible at the store. Such a store-based system provides cross-selling and upselling opportunities: instead of simply warning a purchaser that an item is unneeded and to put the item back, an embodiment makes additional suggestions based on the unneeded item. For example, instead of simply warning a user than an item will expire before it can be used, an embodiment might suggest a different brand or flavor of the same item with a longer expiration date. Instead of simply warning a purchaser than an item is unneeded, an embodiment might suggest that the item is on sale and is not perishable so should be purchased anyway. Upon detecting that a purchaser has added one of an item to a physical shopping cart, an embodiment might suggest that there is a quantity discount on the item and the item is not perishable, so the purchaser should buy more.

The embodiments described herein have been described as implemented as a software application executing on an appropriately-equipped physical shopping cart (cart-side embodiment), in communication with other applications executing on other devices. However, the embodiments may also be implemented on a device carried, worn, or in other proximity to a purchaser, such as a mobile device or wearable device (mobile-side embodiment). A mobile-side embodiment communicates with a cart-side embodiment to establish an association between cart and purchaser and to receive a report of an item being added to the cart. The embodiments may also be implemented on a device remote from both cart and purchaser, such as a server (server-side embodiment). A server-side embodiment communicates with a cart-side embodiment and a mobile-side embodiment to establish an association between cart and purchaser, communicates with a cart-side embodiment to receive a report of an item being added to the cart, and communicates with at least one of a cart-side embodiment and a mobile-side embodiment to communicate with the purchaser.

The manner of controlling physical procurement at point of purchase described herein is unavailable in the presently available methods in the technological field of endeavor pertaining to procurement management of physical items. A method of an embodiment described herein, when implemented to execute on a device or data processing system, comprises substantial advancement of the functionality of that device or data processing system in associating a physical shopping cart and a purchaser, detecting a purchaser's depositing an item into the physical shopping cart, and, based on information associated with the purchaser, determining that the item is unneeded and the purchaser warned prior to purchase.

The illustrative embodiments are described with respect to certain types of physical items, physical shopping carts, predictions, usage rates, associations, detections, thresholds, responses, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

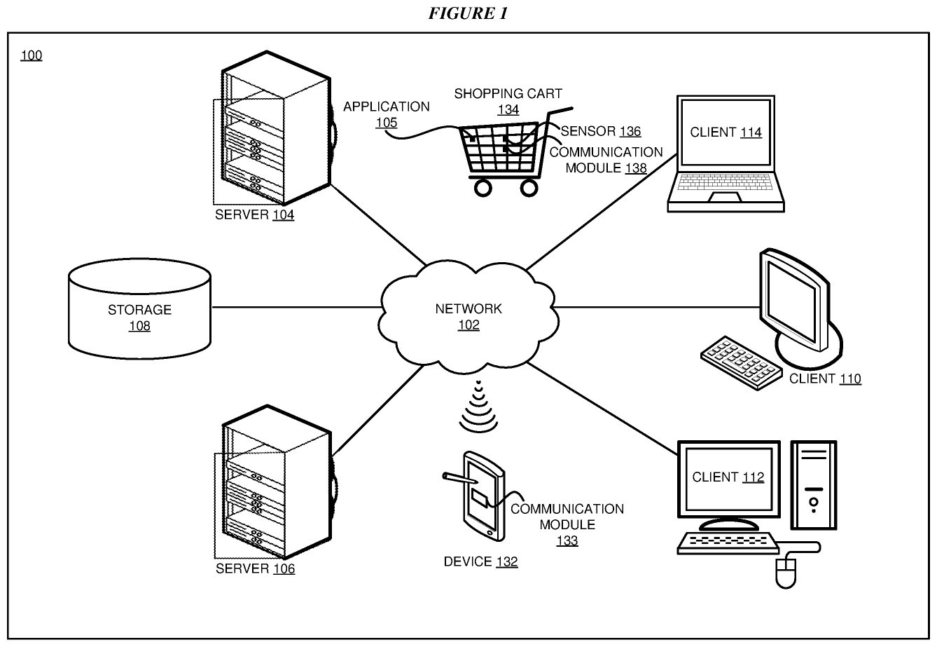

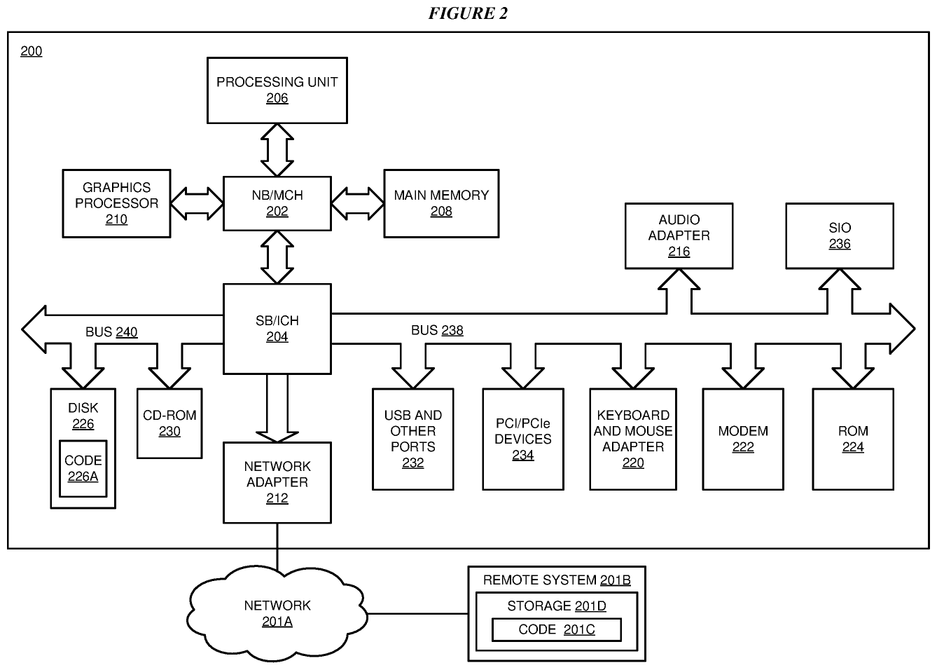

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Shopping cart 134 is an example of a physical shopping cart described herein. Shopping cart 134 includes sensor 136, which is configured to detect item additions to shopping cart 134. Shopping cart 134 also includes communications module 138. Communications module 138 communicates with communications module 133 of device 132, as well as other devices such as servers 104 and 106 and clients 110, 112, and 114 via network 102. Any software application described as executing in another data processing system in FIG. 1 can be configured to execute in shopping cart 134 in a similar manner. Any data or information stored or produced in another data processing system in FIG. 1 can be configured to be stored or produced in shopping cart 134 in a similar manner.

Application 105 implements an embodiment described herein. Application 105 executes in shopping cart 134, using sensor 136 to detect an item added to shopping cart 134 and using communications module 138 to communicate directly with device 132 or over network 102. Application 105 may also execute in device 132, communicating directly with shopping cart 134. Application 105 may also execute in any of servers 104 and 106, clients 110, 112, and 114, and device 132, communicating with shopping cart 134 via network 102.

Servers 104 and 106, storage unit 108, and clients 110, 112, and 114, shopping cart 134, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

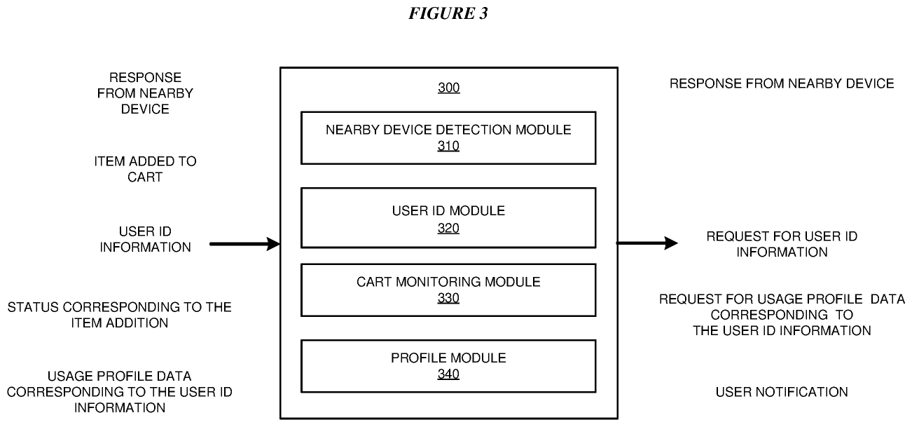

With reference to FIG. 3, this figure depicts a block diagram of an example configuration for controlling physical procurement at point of purchase in accordance with an illustrative embodiment. Application 300 is an example of application 105 in FIG. 1 and executes in shopping cart 134, device 132, or any other suitable device in FIG. 1.

When application 300 executes in shopping cart 134, nearby device detection module 310 broadcasts a request for a response from a suitably equipped device associated with the purchaser. When user ID module 320 receives a response from such a device, including user identification information for the purchaser, module 320 stores the user identification information for item-specific processing. The cart and the purchaser are now deemed to be associated.

When application 300 executes in device 132, nearby device detection module 310 broadcasts a request for a response from a suitably equipped device such as shopping cart 134. When user ID module 320 receives a response from such a device, including cart identification information for shopping cart 134, module 320 stores the cart identification information for item-specific processing. The cart and the purchaser are now deemed to be associated.

Cart monitoring module 330 monitors the environment within and around shopping cart 134 to detect an item addition to shopping cart 134. Cart monitoring module 330 also obtains information about the item—for example, an expiration date or information on a discount available on the item. Profile module 340 uses the identification information for the associated purchaser to obtain profile data for the purchaser.

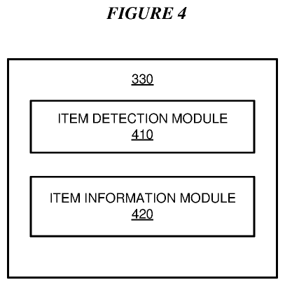

With reference to FIG. 4, this figure depicts more detail of a block diagram of an example configuration for controlling physical procurement at point of purchase in accordance with an illustrative embodiment. In particular, FIG. 4 gives more detail of cart monitoring module 330 in FIG. 3.

Item detection module 410 monitors the environment within and around shopping cart 134 to detect an item addition to shopping cart 134. Module 410 can be configured to monitor using a combination of RFID tags affixed to physical items and an RFID tag reader configured to detect RFID-tagged items as the items enter a volume of the physical cart monitored by the RFID tag reader. Module 410 can also be configured to monitor using weight sensors, cameras, IoT devices, or a combination of sensors and devices.

Item information module 420 gathers information about the detected item. The gathered information includes information such as a description of the item, an expiration date of the item or a lot containing the item, and any temporary or quantity discounts that may be available for the item.

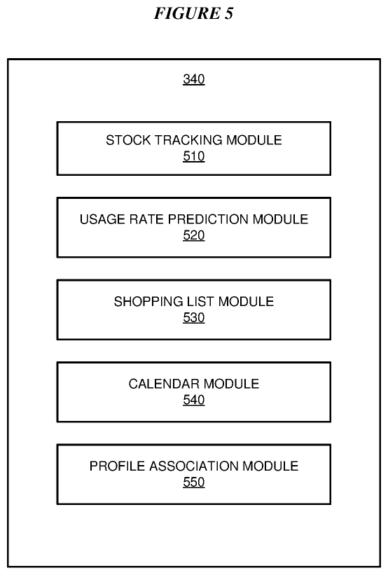

With reference to FIG. 5, this figure depicts more detail of a block diagram of an example configuration for controlling physical procurement at point of purchase in accordance with an illustrative embodiment. In particular, FIG. 5 gives more detail of profile module 340 in FIG. 3.

Stock tracking module 510 tracks stock information for items a purchaser stocks. Stock information includes whether or not the purchaser already has a stock of the item, a quantity of the item, if any, that is currently stocked, expiration data and other age information associated with the current stock of the item, and data showing when which items come into storage and when they are used or must be discarded for expiration or other concerns. Module 510 obtains stock information from another application, or by monitoring stock items themselves or the locations where stock items are stored.

Usage rate prediction module 520 predicts a usage rate of an item based on the stock information of the item. One version of module 520 maintains predicted usage rates of items for which the embodiment also maintains stock information. Another version of module 520 is triggered to predict a usage rate for an item when a physical shopping cart detects that the item has been placed in a cart associated with a purchaser. In either version, tracked stock information is usable to predict future usage, based on historical patterns, calendar and other profile information, and other information.

Shopping list module 530 maintains shopping list information for a purchaser, or receives shopping list information from another application. A purchaser may add items to the shopping list information manually, or module 530 may add items without manual input from a purchaser. Module 530 adds items without manual input when current stock of the item has been used up or is within a threshold time period of being used up, when the embodiment has determined, based on the purchaser's past purchases, that the item should be added, or when the embodiment has determined, from interpreting other profile information of the user that the item should be added, or for another reason.

Calendar module 540 extracts information from the purchaser's calendar, to-do list, reminder application, or another application maintaining information relevant to a purchaser's potential purchases to obtain information that has the potential to impact the rates at which a purchaser uses items. Calendar module 540 uses such data to populate or update a shopping list and to process exceptions to a usage rate prediction for the item. For example, such calendar entries might include items like “Bring 20 juice boxes for snack time,” “Ten guests for dinner Saturday”, or airplane ticket information for a week-long trip.

Profile association module 550 processes information from other users related to the purchaser. Module 550 uses such additional data to populate or update a shopping list and to process exceptions to a usage rate prediction for an item. Thus, if two or more purchasers maintain a common stock of purchased items and share purchasing duties, module 550 takes both purchasers' shopping lists, schedules, to-do lists, and other profile information into account when assessing a need for an item.

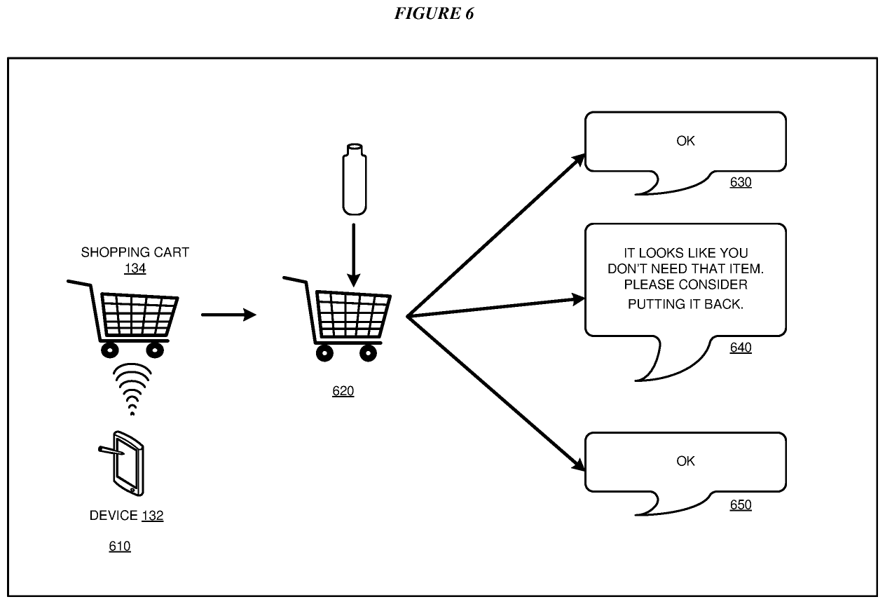

With reference to FIG. 6, this figure depicts examples of the use of an example configuration for controlling physical procurement at point of purchase in accordance with an illustrative embodiment. FIG. 6 shows examples of the results of executing application 300 in FIG. 3. Shopping cart 134 and device 132 are the same as shopping cart 134 and device 132 in FIG. 1.

In state 610, shopping cart 134 and device 132 have communicated with each other and are now associated. Now shopping cart 134 will consider items relative to the profile information for Bob, the user associated with device 132.

In state 620, shopping cart 134 has detected that Bob has put an item into shopping cart 134. Application 300 checks the item against information pertaining to the item and information pertaining to Bob. If the item is a twenty-pack case of small bottles of water, and twenty-pack case of small bottles of water is on Bob's shopping list, application 300 determines that Bob needs the item and does not issue a warning (state 630). If the item is a pint of chocolate ice cream, and Bob already has three pints of the same brand and flavor of ice cream at home that will not expire before Bob's predicted usage rate for ice cream suggests that the ice cream containers at home will be expended, and nothing on Bob's calendar or other profile information indicates an upcoming need for additional ice cream, application 300 determines that Bob does not need the ice cream and issue him a warning (state 640). Note that Bob may still choose to purchase the excess ice cream anyway. On the other hand, if Bob's calendar indicates an entry such as, “make ice cream cake for party tonight,” application 300 determines (state 650) than an exception condition is satisfied, as the excess ice cream is actually needed. In this case, application 300 does not issue a warning.

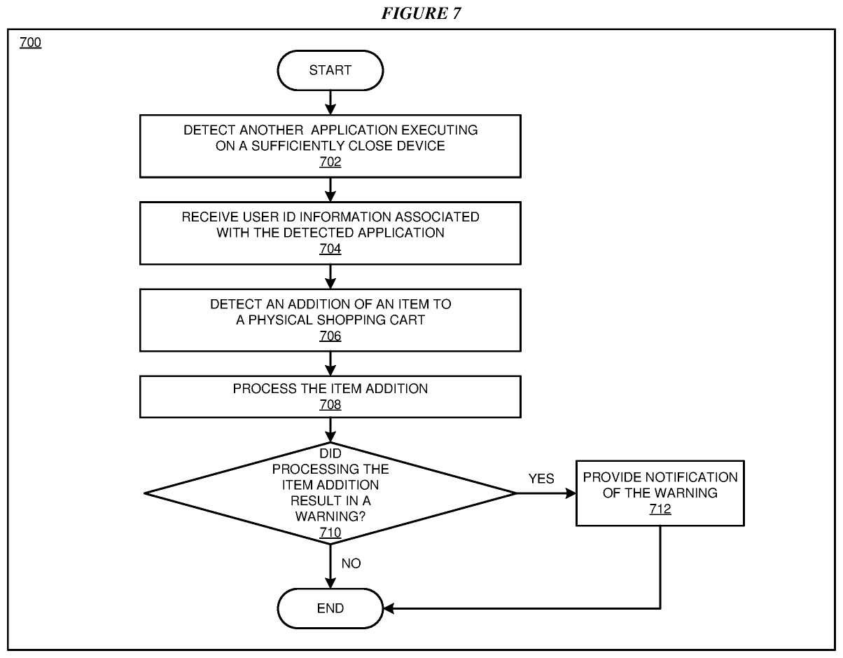

With reference to FIG. 7, this figure depicts a flowchart of an example process for controlling physical procurement at point of purchase in accordance with an illustrative embodiment. Process 700 can be implemented in application 300 in FIG. 3 and executes in any of shopping cart 134, servers 104 and 106, clients 110, 112, and 114, and device 132 in FIG. 1. Nearby device detection module 310, user ID module 320, item monitoring module 330, item information module 420, stock tracking module 510, usage rate prediction module 520, shopping list module 530, calendar module 540, and profile association module 550 are the same as those described with reference to FIG. 3, FIG. 4, and FIG. 5.

In block 702, nearby device detection module 310 detects another application executing on a sufficiently close device. In block 704, user ID module 320 receives and stores user identification information associated with the detected application. In block 706, item monitoring module 330 detects an addition of an item to a physical shopping cart. In block 708, item information module 420, stock tracking module 510, usage rate prediction module 520, shopping list module 530, calendar module 540, and profile association module 550 work together to process the item addition. In block 710, the application determines whether processing the item addition resulted in a warning. If so (“YES” path of block 710), in block 712 the application provides a notification of the warning, either directly to a purchaser or via another application. Then (as well as “NO” path of block 710) the application ends.

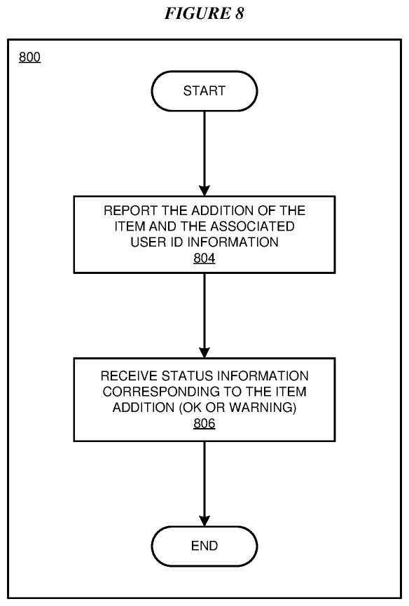

With reference to FIG. 8, this figure depicts another flowchart of an example process for controlling physical procurement at point of purchase in accordance with an illustrative embodiment. Process 800 can be implemented in application 300 in FIG. 3 and includes more detail of block 708 in FIG. 7. Item monitoring module 330, item information module 420, stock tracking module 510, usage rate prediction module 520, shopping list module 530, calendar module 540, and profile association module 550 are the same as those described with reference to FIG. 3, FIG. 4, and FIG. 5.

In block 804, item monitoring module 330 reports the addition of the item and the associated user identification association information to another application, such as one executing on a server or mobile device. In block 806, the application receives status information corresponding to the item addition, as determined by item information module 420, stock tracking module 510, usage rate prediction module 520, shopping list module 530, calendar module 540, and profile association module 550 executing in a remote application. The status information may be an acknowledgement that the item addition is acceptable, or a warning that the added item is not needed and the purchaser should be warned. Then the application ends.

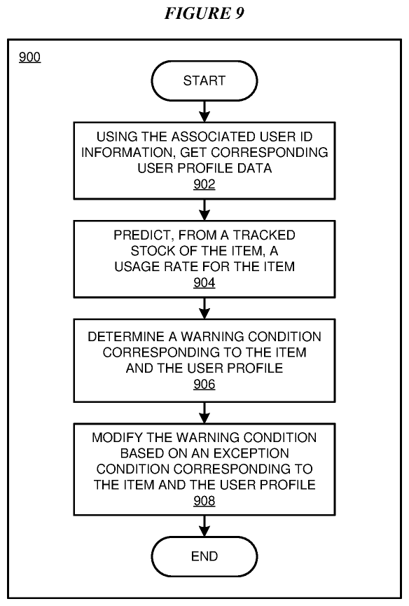

With reference to FIG. 9, this figure depicts another flowchart of an example process for controlling physical procurement at point of purchase in accordance with an illustrative embodiment. Process 900 can be implemented in application 300 in FIG. 3 and includes more detail of block 708 in FIG. 7. Item information module 420, usage rate prediction module 520, shopping list module 530, calendar module 540, and profile association module 550 are the same as those described with reference to FIG. 4 and FIG. 5.

In block 902, the application, using the associated user identification information, receives corresponding user profile data maintained by stock tracking module 510, shopping list module 530, calendar module 540, and profile association module 550. In block 904, usage rate prediction module 520 predicts, from tracked stock information of the item, a usage rate for the item. In block 906, the application, using the predicted usage rate and information from item information module 420, shopping list module 530, calendar module 540, and profile association module 550, determines a warning condition corresponding to the item and the user profile. In block 908, the application, using the predicted usage rate and information from item information module 420, shopping list module 530, calendar module 540, and profile association module 550, modifies or nullifies the warning condition based on an exception condition corresponding to the item and the user profile. Then the application ends.

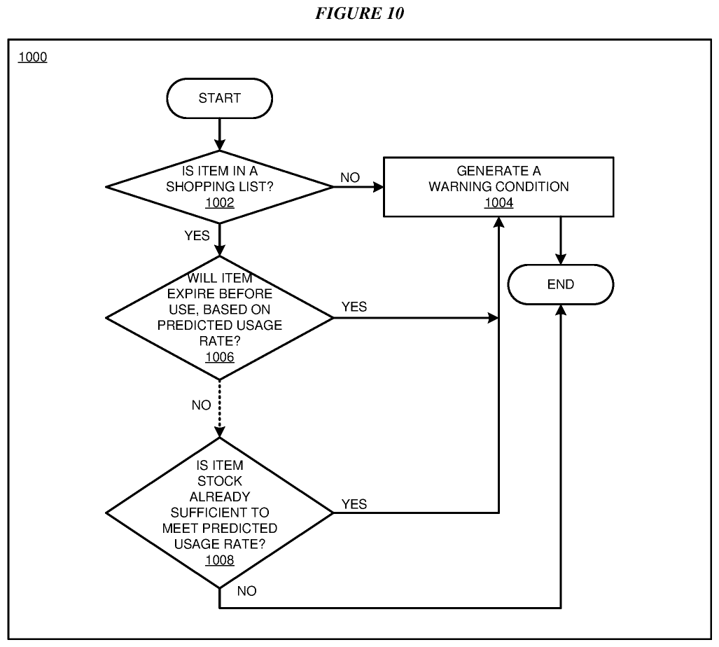

With reference to FIG. 10, this figure depicts another flowchart of an example process for controlling physical procurement at point of purchase in accordance with an illustrative embodiment. Process 1000 can be implemented in application 300 in FIG. 3 and includes more detail of block 906 in FIG. 9. Item information module 420, stock tracking module 510, usage rate prediction module 520 are the same as those described with reference to FIG. 4 and FIG. 5.

In block 1002, shopping list module 530 checks whether the item is in a shopping list. If so (“YES” path of block 1002), in block 1006, item information module 420 checks whether the item will expire before use, based on the predicted usage rate of the item. If not, (“NO” path of block 1006), the application checks other criteria meriting a warning condition. If none of the other criteria are satisfied, in block 1008 stock tracking module 510, usage rate prediction module 520 work together to check whether current stock of the item is already sufficient to meet the predicted usage rate. If not (“NO” path of block 1008), the application ends. Otherwise (“NO” path of block 1002, “YES” path of block 1006, “YES” path of block 1008, and the appropriate path of any additional conditions), in block 1004 the application generates a warning condition, then ends.

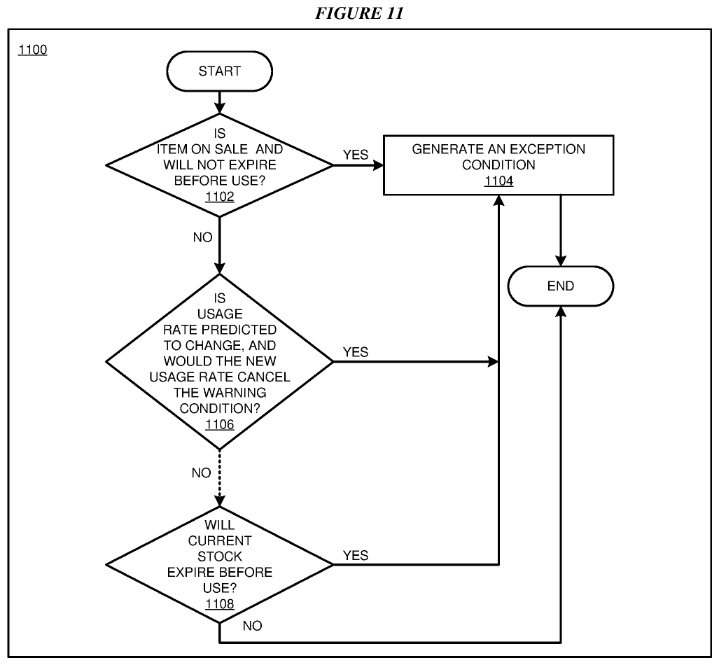

With reference to FIG. 11, this figure depicts another flowchart of an example process for controlling physical procurement at point of purchase in accordance with an illustrative embodiment. Process 1100 can be implemented in application 300 in FIG. 3 and includes more detail of block 908 in FIG. 9. Item information module 420, stock tracking module 510, usage rate prediction module 520, shopping list module 530, calendar module 540, and profile association module 550 are the same as those described with reference to FIG. 4 and FIG. 5.

In block 1102, item information module 420 and usage rate prediction module 520 work together to check whether the item is on sale and will not expire before use. If not (“NO” path of block 1102), in block 1106 usage rate prediction module 520 works with shopping list module 530, calendar module 540, and profile association module 550 to check whether the usage rate is predicted to change, and whether the new usage rate would nullify the warning condition. If not, (“NO” path of block 1006), the application checks other criteria meriting an exception condition. If none of the other criteria are satisfied, in block 1108 stock tracking module 510 and usage rate prediction module 520 work together to check whether current stock of the item will expire before it is predicted to be used. If not (“NO” path of block 1108), the application ends. Otherwise (“YES” path of block 1102, “YES” path of block 1106, “YES” path of block 1108, and the appropriate path of any additional conditions, in block 1104 the application generates an exception condition), then ends.

Thus, a computer implemented method, system or apparatus, and computer program product are provided in the illustrative embodiments for controlling physical procurement at point of purchase and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method comprising:
detecting, using a broadcast signal from a physical item repository and a response to the broadcast signal, a device within a range of the broadcast signal;
determining, from information received from the device using a processor and a memory, profile information comprising a tracked inventory of an item;
detecting, by activation of a sensor, an addition of the item to the physical item repository;
predicting, using the processor using the tracked inventory of the item and a model, a usage rate corresponding to the item;
determining, using the processor responsive to the detecting, a warning condition corresponding to the item relative to the predicted usage rate of the item; and
nullifying, using the processor in response to the determining, the warning condition based on an exception condition, the exception condition determined based on the tracked inventory, the predicted usage rate, and the model, the nullifying preventing the warning condition from occurring.

2. The method of claim 1, further comprising:
configuring the physical item repository to broadcast the signal.

3. The method of claim 1, wherein the broadcast signal is configured to use Near Field Communication.

4. The method of claim 1, wherein the broadcast signal is configured to use Bluetooth.

5. The method of claim 1, wherein the predicting further comprises:
inputting historical pattern information to a forecasting model that is tuned to determine usage rate corresponding to the item from the historical pattern information; and
producing from the forecasting model, a prediction of the usage rate corresponding to the item.

6. The method of claim 1, wherein the predicting further comprises:
inputting calendar information to a forecasting model that is tuned to determine usage rate corresponding to the item from the calendar information; and
producing from the forecasting model, a prediction of the usage rate corresponding to the item.

7. The method of claim 1, wherein the predicting further comprises:
inputting user information to a forecasting model that is tuned to determine usage rate corresponding to the item from the user information; and
producing from the forecasting model, a prediction of the usage rate corresponding to the item; and
combining the predicted usage rate corresponding to the item with another predicted usage rate corresponding to the item to compute the usage rate corresponding to the item.

8. The method of claim 1, wherein determining the warning condition further comprises:
determining, based on the tracked inventory and the predicted usage rate, that the item is currently unneeded.

9. (canceled)

10. A computer usable program product comprising one or more computer-readable storage devices, and program instructions stored on at least one of the one or more storage devices, the stored program instructions when executed by a processor causing operations comprising:
detecting, using a broadcast signal from a physical item repository and a response to the broadcast signal, a device within a range of the broadcast signal;
determining, from information received from the device using a processor and a memory, profile information comprising a tracked inventory of an item;
detecting, by activation of a sensor, an addition of the item to the physical item repository;
predicting, using the tracked inventory of the item and a model, a usage rate corresponding to the item;
determining, responsive to the detecting, a warning condition corresponding to the item relative to the predicted usage rate of the item; and
nullifying, in response to the determining, the warning condition based on an exception condition, the exception condition determined based on the tracked inventory, the predicted usage rate, and the model, the nullifying preventing the warning condition from occurring.

11. The computer usable program product of claim 10, further comprising:
configuring the physical item repository to broadcast the signal.

12. The computer usable program product of claim 10, wherein the broadcast signal is configured to use Near Field Communication.

13. The computer usable program product of claim 10, wherein the broadcast signal is configured to use Bluetooth.

14. The computer usable program product of claim 10, wherein the predicting further comprises:
inputting historical pattern information to a forecasting model that is tuned to determine usage rate corresponding to the item from the historical pattern information; and
producing, from the forecasting model, a prediction of the usage rate corresponding to the item.

15. The computer usable program product of claim 10, wherein the predicting further comprises:
inputting calendar information to a forecasting model that is tuned to determine usage rate corresponding to the item from the calendar information; and
producing, from the forecasting model, a prediction of the usage rate corresponding to the item.

16. The computer usable program product of claim 10, wherein the predicting further comprises:
inputting user information to a forecasting model that is tuned to determine usage rate corresponding to the item from the user information; and
producing, from the forecasting model, a prediction of the usage rate corresponding to the item; and
combining the predicted usage rate corresponding to the item with another predicted usage rate corresponding to the item to compute the usage rate corresponding to the item.

17. The computer usable program product of claim 10, wherein program instructions to determine the warning condition further comprises:
determining, based on the tracked inventory and the predicted usage rate, that the item is currently unneeded.

18. The computer usable program product of claim 10, wherein the stored program instructions are stored in the at least one of the one or more storage devices of a local data processing system, and wherein the stored program instructions are transferred over a network from a remote data processing system.

19. The computer usable program product of claim 10, wherein the stored program instructions are stored in the at least one of the one or more storage devices of a server data processing system, and wherein the stored program instructions are downloaded over a network to a remote data processing system for use in a computer readable storage device associated with the remote data processing system.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to detect, using a broadcast signal from a physical item repository and a response to the broadcast signal, a device within a range of the broadcast signal;
program instructions to determine, from information received from the device using a processor and a memory, profile information comprising a tracked inventory of an item;
program instructions to detect, by activation of a sensor, an addition of the item to the physical item repository;
program instructions to predict, using the tracked inventory of the item and a model, a usage rate corresponding to the item;
program instructions to determine, using the processor responsive to the detecting, a warning condition corresponding to the item relative to the predicted usage rate of the item; and
program instructions to nullify, using the processor in response to the determining, the warning condition based on an exception condition, the exception condition determined based on the tracked inventory, the predicted usage rate, and the model, the nullifying preventing the warning condition from occurring.

21. The method of claim 1, wherein the exception condition is determined based on an expiration status of the tracked inventory.
